(19) United States
(12) Patent Application Publication
(10) Pub. No.: US 2012/0175909 A1
(43) Pub. Date: Jul. 12, 2012

(54) METHOD AND APPARATUS FOR ADJUSTING AND SUPPORTING RECREATIONAL VEHICLE BEDDING

(76) Inventor: JAMES H. Frerichs, Kansas City, MO (US)

(21) Appl. No.: 12/901,519

(22) Filed: Oct. 9, 2010

Related U.S. Application Data
(60) Provisional application No. 61/250,489, filed on Oct. 9, 2009.

(51) Int. Cl. B60P 3/00; F21V 21/00

(52) U.S. Cl. 296/170; 362/382

(57) ABSTRACT

The present invention is directed to a new and improved method and apparatus for assembly, support and adjustment of recreational vehicle bedding. An embodiment of the invention includes a recreational bedding supporting apparatus comprising a bedding base, a vertical support having a stationary leg, a mobile leg, a pivotal structure and a lever, the stationary leg extending towards the pivotal structure and operationally connected to the lever, and a proximal and distal end associated with the lever, the distal end in communication with the mobile leg and the proximal end extending therefrom, whereby the mobile leg is adapted for incremental positioning of the bedding base. The present invention also includes a method for incremental elevation of the recreational bedding vehicle having a bedding base with a pair of support slats above the ground the method including the steps of positioning the jack with the lever between the bedding base and the ground, pivoting the lever having a latching end towards the ground, rotating the latching end of the lever, the latching end associated with the latch operationally connected to a mobile leg having a plurality of slots adapted to receive the latch, positioning the latch within a slot having a bottom releasing surface presenting a cavity for releasable receipt of the latch, the slot associated with the mobile leg, moving the latch out of the cavity and downward against a bottom releasing surface associated with the slot, raising the mobile leg upward in relation to a stationary leg whereby the bedding base is elevated and the supports slats are secured.

### CROSS-REFERENCE TO RELATED APPLICATION

This application claims priority under 35 U.S.C. 119(e) and 37 C.F.R. 1.78(a)(4) based upon copending U.S. Provisional Application, Ser. No. 61/250,489 for JACK FOR LIFTING CAMPER BEDS, filed Oct. 9, 2009, the disclosure of which is incorporated by reference.

### FIELD OF THE INVENTION

The invention relates to a method and apparatus for assembling, supporting and adjusting recreational vehicle bedding such as that found on “pop-up” campers and the like, and, more specifically, one embodiment includes a stabilizing jack, bedding and support slats.

### BACKGROUND OF THE INVENTION

There are a variety of recreational vehicles which are designed to travel more compactly through the use of retractable bedding. One example of such a vehicle is what is commonly referred to as the “pop-up” camper, variations of which have been in use for over one hundred years. The pop-up camper is typically attached for transport to a truck, van or other vehicle using a hitch arrangement. At least a portion of the camper's outer walls is usually composed of either flexible materials or retractable panels. By collapsing these flexible materials or retractable panels and folding them into the body of the camper and allowing the associated roofing materials to rest on the body of the camper, it becomes a smaller profile trailer for traveling.

One common feature of many campers is at least one bed with at least a portion of its length extending horizontally (upon completed assembly) from its sidewalls. There are several possible bedding designs including beds supported by slats extending diagonally from the base of the bedding downward toward the ground or to a portion of the camper, supported by slats extending from the base of the bedding upward toward and being secured to a portion of the camper or external support structure, or supported simply by a rigid base.

As regards bedding supported by slats which extend from the base of the bedding, many designs employ detachable slats which, when assembling, must have one end attached to the bedding and the other to the ground or other support structure such as a portion of the camper. During the assembly process, an operator typically will grasp the bedding, pull or push to extend it from the body of the camper, and then maneuver it into a particular height or angular position appropriate for attaching the support slats. It is common for such techniques to result in bodily strain on the operator due to the forces employed and bodily positions required to support the bedding while attempting to maneuver the support slats into position.

Additionally, during use of the assembled bedding, often a camper may wish to incline the bedding to an angular position outside the range allowed by associated support slats. Alternatively, a camper may have misplaced one or more of the support slats and may require additional bedding support.

Heretofore, there exists a need for an improved method and apparatus for assembly of recreational vehicle bedding as well as for support and angular positioning of the assembled bedding during use.

### SUMMARY OF THE INVENTION

The present invention is directed to a new and improved method and apparatus for assembly, support and adjustment of recreational vehicle bedding. An embodiment of the invention includes a recreational bedding supporting apparatus comprising a bedding base, a vertical support having a stationary leg, a mobile leg, a pivotal structure and a lever, said stationary leg extending towards said pivotal structure and operationally connected to said lever, and a proximal and distal end associated with said lever, said distal end in communication with said mobile leg and said proximal end extending therefrom, whereby said mobile leg is adapted for incremental positioning of said bedding base. The present invention also includes a method for incremental elevation of the recreational bedding vehicle having a bedding base with a pair of support slats above the ground with a jack said method including the steps of positioning the jack with a lever between the bedding base and the ground, pivoting said lever having a latching end towards the ground, rotating said latching end of said lever, said latching end associated with a latch operationally connected to a mobile leg having a plurality of slots adapted to receive said latch, positioning said latch within a slot having a bottom releasing surface presenting a cavity for releasably receiving said latch, said slot associated with said mobile leg, moving the latch out of said cavity and downward against a bottom releasing surface associated with said slot, raising said mobile leg upward in relation to a stationary leg whereby said bedding base is elevated, and securing said support slats.

### BRIEF DESCRIPTION OF THE DRAWINGS

For a better understanding of the present invention, and to show more clearly how it may be carried into effect, reference will now be made by way of example to the accompanying drawings. Directional and orientation references are for convenience only and are not intended as limiting aspects of the invention. The drawings show preferred embodiments of the present invention, in which:

FIG. 1 depicts a typical collapsed pop-up camper.

FIG. 2 depicts a typical assembled pop-up camper.

FIG. 3 depicts an embodiment of the apparatus being used with the method for bedding assembly.

FIG. 4 depicts an embodiment of the apparatus from a side view which includes an optional means for illumination.

FIG. 5 is a sectional depiction of an embodiment of the apparatus from a side view of the pivotal structure area including portions of the lever, stationary and mobile legs, as well as the latch.

FIG. 6 is a sectional depiction of an embodiment of the apparatus from a frontal view of portions of the latching end of the lever and the mobile leg, as well as the latch being received into one of the mobile leg's slots.

FIG. 7 is a top view of a cross-section of an embodiment of the apparatus showing an exemplary assembly of the components present in the pivotal structure area.

FIG. 8 depicts an embodiment of the stationary leg from a side view.

FIG. 9 is a bottom view of a cross-section of an embodiment of the stationary leg.

FIG. 10 is a top view of a cross-section of the lower portion of an embodiment of the stationary leg including an optional stationary leg base.

FIG. 11 is a side view of an embodiment of the mobile leg.

FIG. 12 is a bottom view of a cross-section of the upper portion of an embodiment of the mobile leg including an optional mobile leg cap.

FIG. 13 is a top view of an embodiment of the lever.

FIG. 14 is a side view of an embodiment of the lever.

FIG. 15 is a cross-sectional front view of the distal latching end of an embodiment of the lever including latch and side members.

FIG. 16 is a back view of the proximal end of an embodiment of the lever.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure.

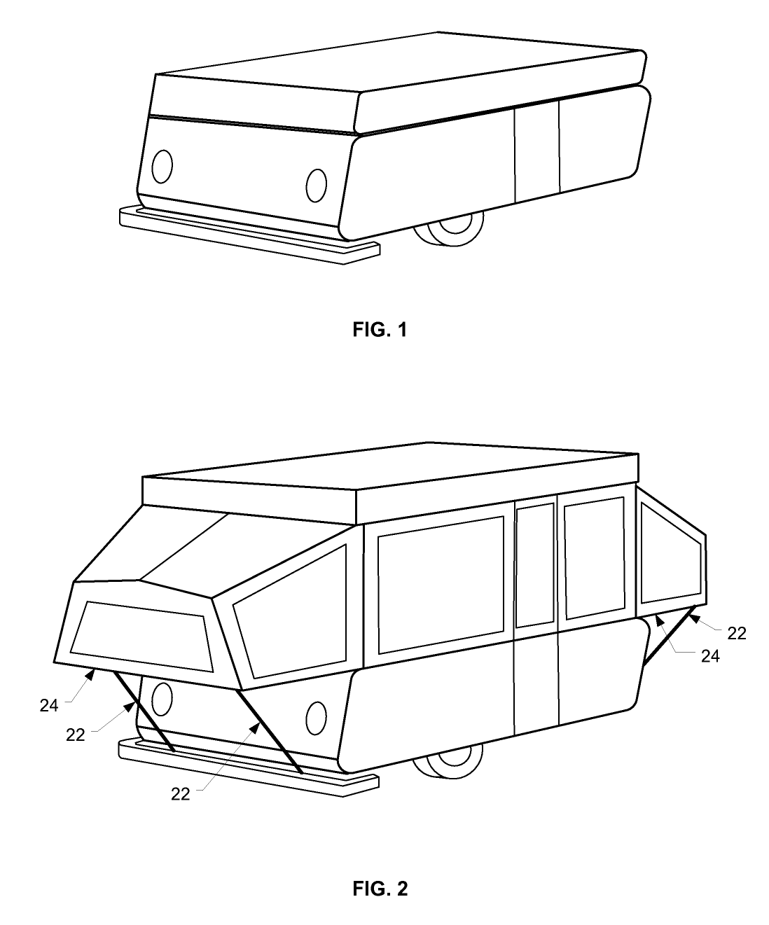

FIGS. 1 and 2 depict traditional collapsed and assembled pop-up campers, respectively. FIG. 1's collapsed camper presents a smaller profile more appropriate for travel, with retractable portions of the sidewalls (not shown) folded inward and collapsed into the body of the camper. FIG. 2 depicts a traditional assembled camper with retractable portions of the sidewalls deployed and extending from the body of the camper or from portions of the bedding upward toward the camper's roof section. The bedding is depicted extending horizontally from the sidewalls of the camper with each bed supported by slats 22 extending downwardly from the base 24 of the bedding toward a portion of the camper body to which they are attached. A bedding base 24 is typically comprised of a rigid material which helps support and prevent substantial bending of the overlying mattress or bedding materials when the bed is extended from the body of the camper and assembled.

Of course, there are myriad bedding and bedding support designs employed by campers in use across the United States and the world. For example, some slats 22 extend upward from the base 24 and are attached to portions of the camper or other support structures, thus supporting the bedding through resistance to tensile forces. These slats may be made of rigid materials such as wood, steel or aluminum alloys or of straps comprised of flexible materials which are also capable of withstanding tensile forces. In other designs, such as that shown in FIG. 2, slats 22 may extend downward and are supported by the ground or other support surface, thus supporting the bed through resistance to compressive forces. These slats 22 may be made of rigid materials such as wood, steel or aluminum alloys capable of withstanding the compressive forces.

Slats 22 may be associated with the bedding base 24 using a variety of structures or attachment devices known by persons of ordinary skill in the art. For example, the base 24 may have apertures formed within it to receive an end of the slat 22; alternatively, an attachment device having a receiving aperture may be fastened to the base 24 using conventional fastening devices such as screws or nails. The opposing end of the slat 22 may be secured to the camper body or other support surface by using similar apertures or attachment devices. Alternatively, either end may simply be designed to rest against the base 24 or support surface.

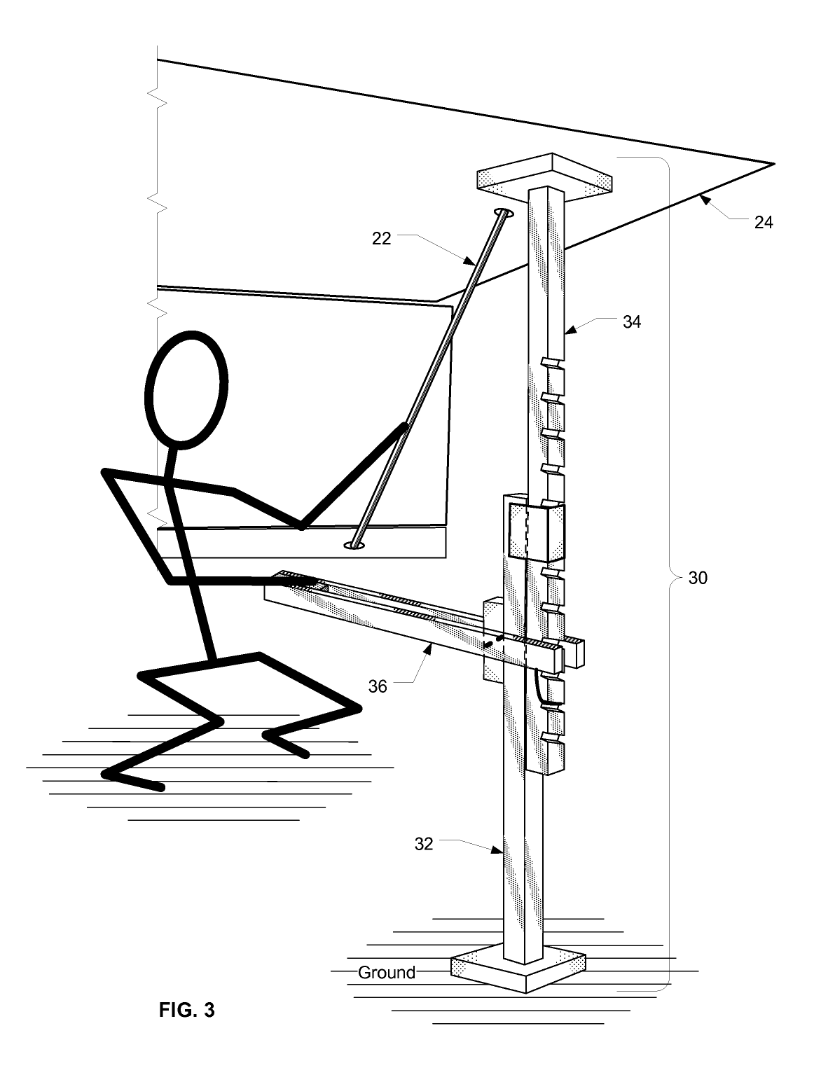

FIG. 3 depicts an embodiment of the invention comprising a bedding base 24 supported by two slats 22 extending diagonally and downward from the base 24 toward the body of the camper. The base 24 is also supported by a jack 30 extending from the base 24 downward to the ground. The jack 30 is comprised generally of a stationary leg 32 which is shown contacting the ground support surface and extending upward to a pivotal structure where a lever 36 is pivotally associated with it. The jack 30 is also comprised of a mobile leg 34 which extends upward alongside the stationary leg 32 and terminates in contact with the bedding base 24.

As will be appreciated from FIG. 3, the jack 30 is generally longer and capable of support at greater heights in comparison with many jacks employed for use in elevating cars or the like. Its usage with camper bedding materials also allows the jack 30 to be comprised of components made of relatively light materials such as wood.

In operation, the bedding of the assembled camper in FIG. 3 may be supported by the jack 30 during occupation of the camper or may optionally be elevated using the jack 30 to different desired elevations or angles. These options, for example, may be useful where slats 22 have gone missing or are unavailable or where an occupant of the camper desires to change the angle of the bedding for use outside of the angular range, if any, provided through exclusive use of slats 22.

The jack 30 may also be used during assembly of the bedding for support and incremental elevation. An operator may begin by placing the stationary leg 32 against a support surface such as the ground and the opposite end of the mobile leg 34 against the base 24 or other structure associated with the base 24. By then pivoting the lever 36 about the stationary leg 32, the operator may cause the incremental elevation of the bedding through the resulting upward movement of the mobile leg 34.

Regarding the additional task of positioning support slats 22 during assembly, the operator may pivot the lever 36 using one hand while positioning a slat 22 using the other. He may also choose to cyclically raise the bedding to a particular level using the lever 36, check whether the slat(s) 22 is appropriately positioned for attachment to the base 24 and support surface, then return to the lever 36 for additional elevation when necessary. In either case, the operator is not required to support and manipulate the bedding using his own body, nor is he required to attempt to maneuver the slats 22 into position concurrently with supporting the bedding. He may simply pivot the lever 36 at times of his choosing and maneuver the slats 22 at his leisure.

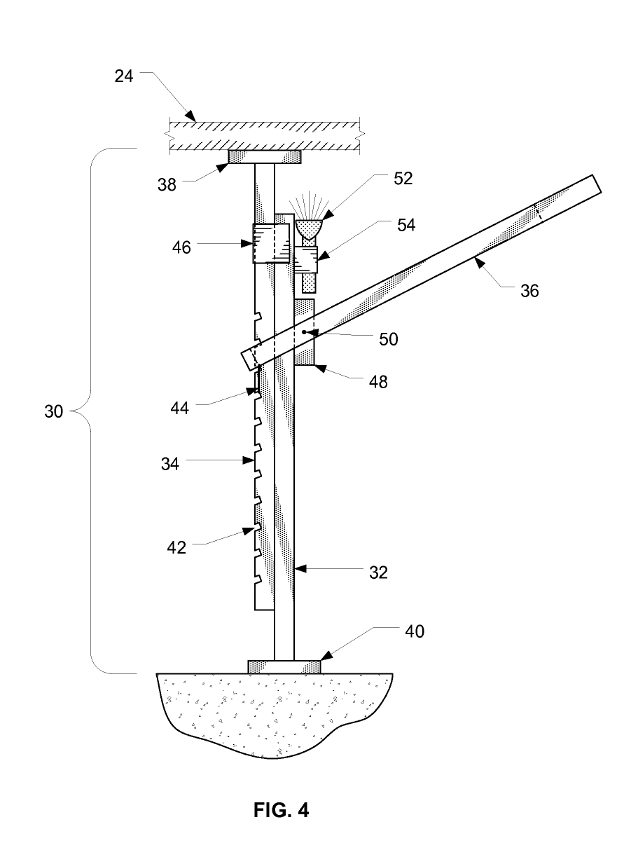

FIG. 4 provides additional detail for the structure of an embodiment of the jack 30. The upper end of the mobile leg 34 is further comprised of a mobile leg cap 38 which is positioned beneath the bedding base 24 Likewise, the lower end of the stationary leg 32 is further comprised of a stationary leg cap 40 which is positioned above the ground or other support surface. From the stationary leg cap 40, the stationary leg 32 extends upward to its pivotal structure, which is pivotally associated with the lever 36. In this embodiment, the pivotal structure is comprised of a pivot block 48 fastened to the main shaft of the stationary leg 32 on the side proximal to an operator (not pictured), a pivot block hole 58 (shown in FIG. 9) extending through the pivot block 48, and a pivot pin 50 rotatably extending through the pivot block hole 58. The pivot pin 50 further extends from the sides of the pivot block 48 where it is pivotally associated with the lever 36. The lever 36 extends away from the pivotal structure toward the operator and, in the other direction, extends away from the pivotal structure to its latching end.

The stationary leg 32 continues to extend upward from its pivotal structure and is additionally fixed to a mobile leg guide 46 located on the side distal from the operator and to an optional light bracket 54 on the side proximal to the operator. The light bracket 54 may be fastened to the stationary leg 32 using conventional fasteners such as screws or nails or, optionally, using a ball-and-socket, track, magnetic or other structure known in the art which allows adjustment of the bracket 54 in relation to the stationary leg 32. It may also be removably fixed to the jack 30 using clips, magnets, or other known structures. The bracket 54 optionally contains a fixed or removable light 52; in this case the light is depicted as a conventional flashlight which is generally pointed upward toward the base 24 for illumination of the area where the mobile leg 34 comes into contact with the base 24. The fixed or removably attached bracket 54 and light 52 may be positioned at differing locations on the jack 30 from that of the depicted embodiment to allow for illumination of alternative areas.

The mobile leg 34 extends downward from the mobile leg cap 38 toward the top of the stationary leg 32 and continues to extend down alongside the stationary leg 32 until it reaches the mobile leg guide 46. The mobile leg guide 46 is fixed to the stationary leg 32 and is depicted as a thin, elongated bracket forming a perimeter around a space through which the mobile leg 34 may movably extend. The mobile leg 34 thus extends through the mobile leg guide 46 down alongside the stationary leg 32 until it terminates near the bottom of the jack 30. The mobile leg's 34 distal surface is further comprised of slots 42 for receiving the latching end of the lever 36.

Having positioned the jack 30, as shown in FIG. 4, between the bedding base 24 and the ground, an operator may grasp the proximal end of the lever 36 and slowly push or pull that end toward the ground causing the lever 36 to pivot about the pivot pin 50. This pivot causes the latching end to move upward along with the mobile leg 34 to which it is latched. Following this incremental movement of the mobile leg 34, the operator may push or pull the proximal end of the lever 36 away from the ground causing the latching end to release one slot 42 in the mobile leg 34 and re-enter a lower one.

At any point during this process, the operator may removably fasten a clip or other known retainer fastened to one or both of the stationary and mobile legs 32, 34 to help prevent vertical movement in relation to each other. Said retainer may be used to supplement the support provided by a releasable lock 61 (as shown in FIG. 9 and described below). Using these separately or in combination will allow the operator to have two free hands with which to position the slats 22 between the base 24 and a support surface. If he then determines that the base 24 is in an improper position to receive the slats 22, he may return to the lever 36 and undergo additional iterations to raise the bedding base 24 to an acceptable level. Alternatively, the operator may forego use of the fastener and releasable lock 61 and simply keep one hand on the lever 36 while using the other to telescope the slat 22 into position.

If the operator is not using the jack 30 for assembly of the bedding, he may wish to use it to provide additional support for the base 24, or to adjust the angle and height of the base 24 during use. In such cases, he may simply elevate the bedding to the desired height and employ a releasable lock 61 or retainer to substantially immobilize vertical movement between stationary and mobile legs 32, 34.

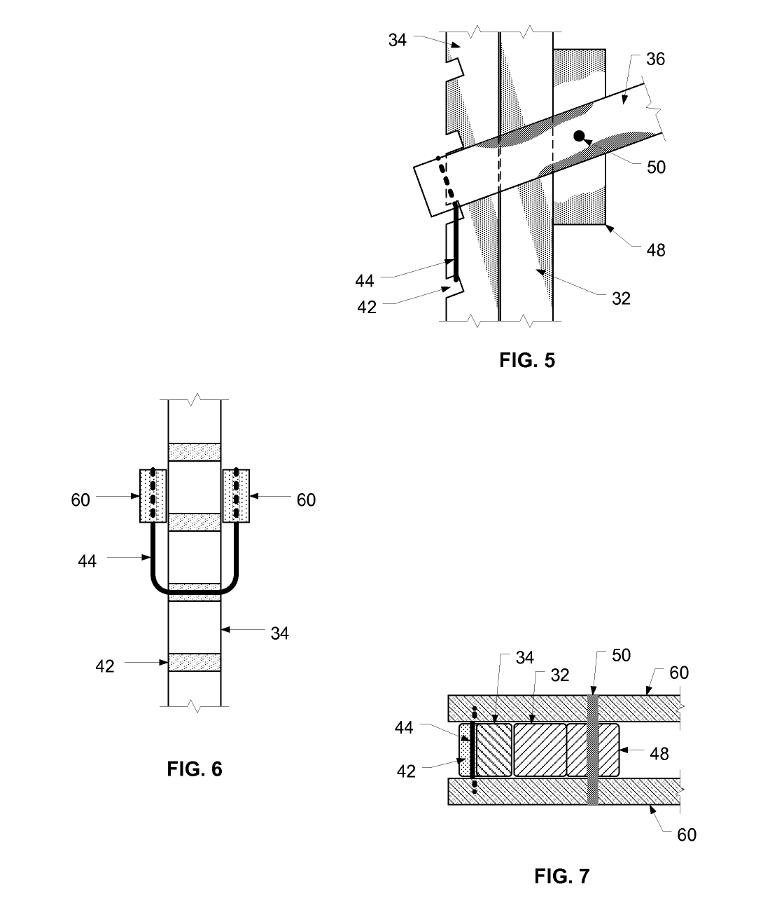

FIG. 5 depicts the pivotal structure and nearby portions of the lever 36, stationary leg 32, and mobile leg 34 in more detail. A plurality of slots 42 are mounted along mobile leg 34 and are each comprised of a top protruding lip having a surface which extends from the interior of a cavity associated with said slot 42 downwardly toward an outer distal surface of the mobile leg 34, thus forming a lip around which the latching end of the lever 36 may catch. Each slot 42 includes a bottom releasing surface for receiving the latch end of the lever as the mobile leg 34 extends towards the interior of the slot 42 cavity.

The latching end of the lever 36 is further comprised of a latch 44 which, in FIG. 5, is a cable secured to the latching end of the lever 36 using conventional mechanical fasteners such as screws, nails or staples. The latch 44 consists of wire or other materials capable of withstanding tensile pressure caused by lifting or supporting the mobile leg 34. In FIG. 5, the latch 44 is shown positioned within slot 42 and, more specifically, is positioned near the top protruding lip. In this position, the proximal end of the lever 36 is positioned for pivotal movement toward the ground allowing the latching end of the lever to rotate and the latch 44 to move upward. In operation, when the latch 44 is rotated for location within slot 42, the mobile leg 34 moves upwardly in relation to the stationary leg 32. Continuing, the proximal end of the lever 36 may be pivoted away from the ground allowing the latch 44 to move downward against the bottom releasing surface of slot 42 and out of its cavity and down into a relatively lower slot 42 if desired. The jack 30 may then be prepared for another increment of elevation. In this manner, the jack 30 provides for incremental elevation of the bedding with minimal effort of the operator. An aspect of the invention is thus the capability to make small, controlled adjustments of the height of the bedding which may reduce the strain of elevating the bedding and the possibility of inadvertently displacing slats during and following assembly.

The lever 36, as discussed above, is pivotally associated with the pivot block 48 using the pivot pin 50 which extends through the pivot block hole 58 and out from a side of the block 48. An embodiment of this pivotal association is shown in more detail in FIG. 7. The pivot block hole 58 is shown, from a top perspective, extending horizontally through the pivot block 48. As illustrated, the pivot block 48 may be fixed to the proximal side of the stationary leg 32.

As illustrated, the pivot pin 50 extends from the sides of the pivot block 48 into the lever 36. More specifically, the pivot pin 50 is rotationally or fixedly associated with two sides of the lever 36 which are referred to here as lever side members 60. The pivot pin 50 is shown extending into and through the side members 60. The pin 50 may be rotationally associated with the side members 60 using, for example, caps placed on either end of the pin 50 to reduce side-to-side movement of the pin 50 and thus prevent the pin 50 from sliding out of contact with one or more of the side members 60. Another type of rotational association may be achieved using one or more pins inserted through the width of the pin 50 which also would reduce side-to-side movement of the pin 50. Alternatively, the pin 50 may be fixed to the side members 60 using conventional fasteners such as adhesives as shown in FIG. 7. Each of these allows the lever 36 to be pivotally associated with the pivot block 48 and stationary leg 32.

FIG. 9 provides additional detail regarding the mobile leg guide 46. The mobile leg guide 46 is shown as a thin bracket fixed to the stationary leg 32 using conventional fasteners. Spacers 56 are shown between the side surfaces of the stationary leg 32 and the associated inner surfaces of the mobile leg guide 46. To facilitate extension of the mobile leg 34 in relation to the mobile leg guide 46, the guide 46 may be dimensioned wider than the stationary and mobile legs 32, 34. Spacers 56 may be used to accommodate this additional width by filling what would otherwise be a gap between the guide 46 and the stationary leg 32. Spacers 56 may be comprised of any of a variety of materials including plastic, metal or wood which may be held in place through the friction and pressures created by fixing the guide 46 to the stationary leg 32 or through association with glues or mechanical fasteners such as nails or screws.

Also shown in FIG. 9 is an optional releasable lock 61 shown in association with the mobile leg guide 46. The illustrated embodiment of the releasable lock 61 includes a flange which is associated with the inner surface of the mobile leg guide 46 which generally faces the slotted distal surface of the mobile leg 34. The flange extends from a lower edge, which is hinged or otherwise associated with the mobile leg guide 46 so as to allow it to swing toward and away from the mobile leg 34, upward and away from the inner surface of the mobile leg guide 46. In this manner, the flange is designed to be received into the slots 42 as the mobile leg 34 travels incrementally upward. Between the inner surface of the mobile leg guide 46 and the flange is a spring, as pictured in FIG. 9, which as illustrated depicts securing the spring to both the mobile leg guide 46 and the flange and operationally biases the flange toward the mobile leg 34. The mobile leg 34 may be positioned vertically to provide pressure against the bedding in association with pivoting the lever 36. In the embodiment illustrated in FIG. 9, pivoting the lever 36 may position the flange of the releasable lock 61 into consecutive slot 42. If desired, pressure associated with the lever 36 may be reduced by inserting the releasable flange associated with the releasable lock 61 into slot 42. In this manner, when the operator releases the lever 36, the mobile leg 34 will be held in position relative to the stationary leg 32 by the releasable lock 61.

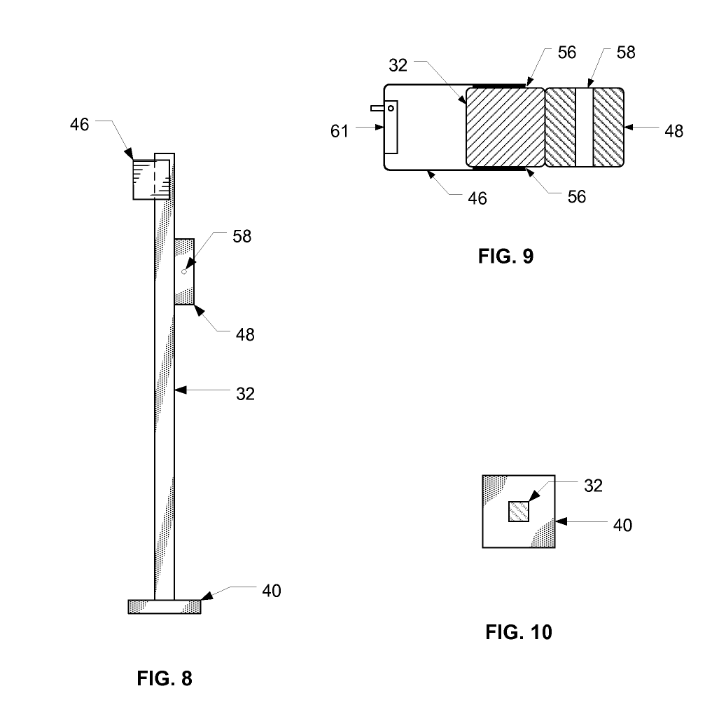

As shown in FIG. 8, the releasable lock 61 may further include a release bar which, in one embodiment, extends from a fixed position associated with the flange away from the mobile leg 34. The release bar as shown is employed by pressing its lower end toward the mobile leg 34 allowing movement of the flange in relation to slot 42, thereby facilitating slideable movement of mobile leg 34 in relation to stationary leg 32.

The optional releasable lock 61 may be used in conjunction with an optional clip or similar structure to limit movement of the mobile leg 34 in relation to the stationary leg 32 as desired; for example when the operator is not elevating the bedding.

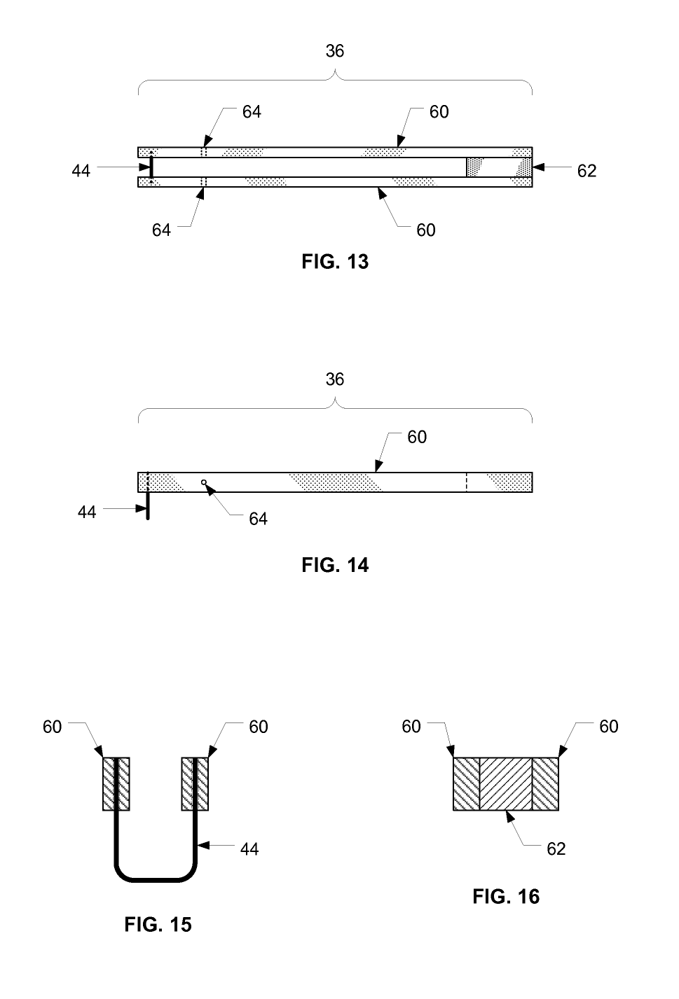

FIG. 13 depicts the structure of an embodiment of the lever 36 in greater detail. As illustrated, the lever 36 includes latch 44 adapted for releasable insertion into the slot 42 associated with mobile leg 34. As depicted, the latch 44 is secured to both lever side members 60. The side members 60 extend toward the operator and include, near the latching end, lever pivot holes 64 through which the pivot pin 50 extends. The side members 60 are optionally joined, in the embodiment shown in FIGS. 13 and 16, by a lever handle spacer 62 on the lever's 36 proximal end. The lever handle spacer 62 is generally comprised of a rigid material and secured between the side members 60, thus substantially maintaining their separation and allowing for improved coordination of their movement.

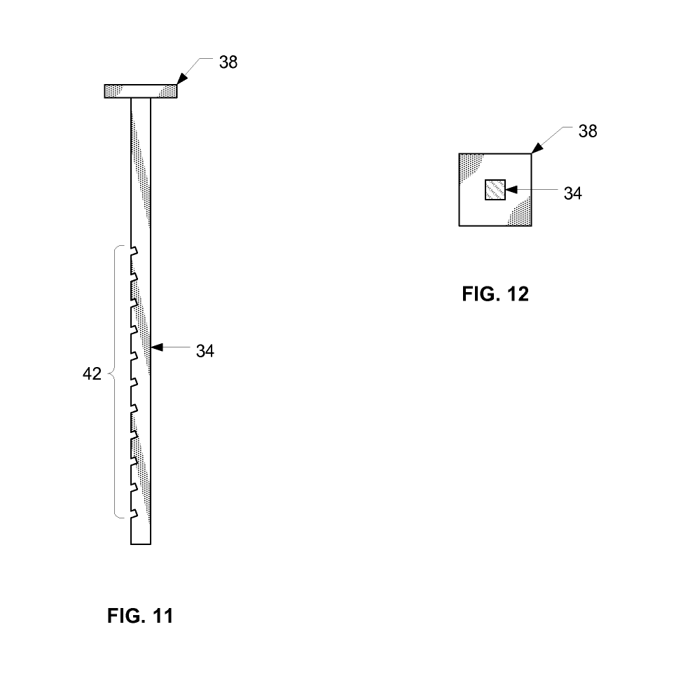

FIGS. 10 and 12 respectively show stationary and mobile leg caps 40, 38. These caps 40, 38 contact ground or other support surfaces and the base 24 and increase the cross-sectional area of contact with these surfaces. Caps 40, 38, however, are optional and may have a variety of characteristics for improving frictional properties between the mobile and stationary legs 34, 32 and their respective bedding base 24 and associated support surfaces. Additionally, these caps 40, 38 may be fixed or releasably fixed to the base 24 or support surfaces using conventional mechanical fasteners in order to limited undesired slippage between the surfaces and the caps 40, 38 during operation.

While the foregoing detailed description has disclosed several embodiments of the invention, it is to be understood that the above description is illustrative only and not limiting of the disclosed invention. It will be appreciated that the discussed embodiments and other unmentioned embodiments may be within the scope of the invention.

Having thus described the invention, what is claimed as new and desired to be secured by Letters Patent is as follows:

1. A recreational bedding supporting apparatus comprising:
a bedding base
a vertical support having a stationary leg, a mobile leg, a pivotal structure and a lever, said stationary leg extending towards said pivotal structure and operationally connected to said lever, and
a proximal and distal end associated with said lever, said distal end in communication with said mobile leg and said proximal end extending therefrom, whereby said mobile leg is adapted for incremental positioning of said bedding base.

2. The recreational bedding supporting apparatus of claim 1 further comprising a plurality of slots mounted along said mobile leg adapted for receiving a latching end of the lever.

3. The recreational bedding supporting apparatus of claim 2 wherein each slot includes a bottom releasing surface for receiving the latching end of the lever.

4. The recreational bedding supporting apparatus of claim 1 wherein said mobile leg extends upwardly along said stationary leg towards said bedding base.

5. The recreational bedding supporting apparatus of claim 1 further comprising a pair of slats extending diagonally from said bedding base.

6. The recreational bedding supporting apparatus of claim 1 wherein said mobile leg further comprises a mobile leg cap positioned beneath said bedding base.

7. The recreational bedding supporting apparatus of claim 1 wherein said stationary leg further comprises a stationary leg cap, wherein said stationary leg extends between said stationary leg cap to said pivotal structure.

8. The recreational bedding supporting apparatus of claim 1 wherein said pivotal structure further comprises:
a pivot block secured at said stationary leg; and
a pivot block receiver adapted for receiving a pivot pin rotatably extending therethrough for engagement by said lever.

9. The recreational bedding supporting apparatus of claim 1 further comprising a mobile leg guide located opposite said lever and receiving a light bracket.

10. The recreational bedding supporting apparatus of claim 1 wherein said stationary leg is associated with a mobile leg guide spaced from a light bracket adapted for illumination.

11. The recreational bedding supporting apparatus of claim 10 wherein said light bracket is secured to said stationary leg.

12. The recreational bedding supporting apparatus of claim 1 further comprising a retainer.

13. The recreational bedding supporting apparatus of claim 12 wherein said retainer is in communication with a releasable lock for limiting undesired vertical movement of said stationary leg in relation to said mobile leg.

14. The recreational bedding supporting apparatus of claim 1 further comprising a mobile leg guide located opposite said lever and receiving a light bracket.

15. A method for incremental elevation of a recreational bedding vehicle having a bedding base with a pair of support slats above the ground with a jack said method including the steps of:
positioning the jack with a lever between the bedding base and the ground;
pivoting said lever having a latching end towards the ground;
rotating said latching end of said lever, said latching end associated with a latch operationally connected to a mobile leg having a plurality of slots adapted to receive said latch;
positioning said latch within a slot having a bottom releasing surface presenting a cavity for releasably receiving said latch, said slot associated with said mobile leg;
moving the latch out of said cavity and downward against a bottom releasing surface associated with said slot releasing said;
raising said mobile leg upward in relation to a stationary leg whereby said bedding base is elevated; and
securing said support slats.
